(19) United States
(12) Patent Application Publication
(10) Pub. No.: US 2006/0172119 A1
(43) Pub. Date: Aug. 3, 2006

(54) Reflection preventing molding and method of manufacturing the same

(76) Inventors: Masahiko Hayashi, Yokosuka-shi (JP); Hitoshi Ooishi, Takaoka-shi (JP)

Correspondence Address: BIRCH STEWART KOLASCH & BIRCH, PO BOX 747, FALLS CHURCH, VA, 22040-0747, US

(21) Appl. No.: 10/564,093

(22) PCT Filed: Jul. 23, 2004
(86) PCT No.: PCT/JP04/10905

§ 371 Date: Jan. 11, 2006

(30) Foreign Application Priority Data
Jul. 24, 2003 (JP) 2003-279092

(51) Int. Cl. B29C 45/00

(52) U.S. Cl. 428/156; 264/328.1

(57) ABSTRACT

An antireflection molded article of a thermoplastic resin has an antireflection face having fine protrusions or depressions of pyramids, cones or prisms and entirely or partially formed with inclined faces of the protrusions and the depressions. The average of heights of the protrusions or depths of the depressions is 50 to 600 nm. The average distance between adjacent protrusions or depressions is 50 to 400 nm. The inclined faces of protrusions or depressions has an arithmetic average roughness (Ra) of 100 nm or smaller. The article has a very small reflectance. The process for producing the article comprises forming a shape having protrusions and/or depressions on the surface of a mold core or a stamper using a fine cutting machine and a diamond cutting tool in a room controlled at a prescribed temperature±0.1° C. and injection molding the thermoplastic resin using a mold having the mold core or the stamper having the above shape.

### TECHNICAL FIELD

The present invention relates to an antireflection molded article and a process for producing the article. More particularly, the present invention relates to an antireflection molded article having a very small reflectance and a process for efficiently producing the article.

### BACKGROUND ART

CRT displays, liquid crystal displays and plasma displays are widely used as the terminal display apparatus. When indoor lighting or sun light is reflected at the surface of the display, difficulty arises in watching images on the display, and it is necessary that reflection of light at the surface of a display be prevented.

Heretofore, antireflection films formed by laminating a plurality of thin films having different refractive indices have been used as the means for preventing reflection on the surface of displays. Since the antireflection films are prepared by forming the thin layers in accordance with the vacuum vapor deposition or the like, facilities of a great scale and a long time are required for the preparation. Therefore, as a means for providing the antireflection property more easily, an antireflection film which is constituted with an outermost layer having a rough surface in which ultrafine particles are completely exposed and the air and the ultrafine particles are mixed together and layers containing the ultrafine particles which are adjacent to the outermost layer, the refractive index of the ultrafine particles being the same as or smaller than that of the substrate material, and has a refractive index clearly increasing from the outermost layer to the lower layers, is proposed (Patent Reference 1). Ultrafine particles and a binder having specific refractive indices are necessary for producing this antireflection film, and a long time is required for the production although facilities of a great scale are not required.

To overcome this problem, a process for providing the antireflection property by providing fine protrusions and depressions to the surface of the substrate material without using materials other than the substrate material is proposed. Examples of such proposals include an antireflection article in which a shape having protrusions and depressions is formed continuously in the horizontal direction in a manner such that the pitch between adjacent protrusions or depressions is in the range of 10 to 300 nm (Patent Reference 2), a process for forming pyramidal shapes on an optical device by forming a metal mask on the optical device as an array of dots, followed by treating by etching with a reactive ion to gradually decrease the diameter of the metal mask until the metal mask finally disappears (Patent Reference 3), an injection molded article obtained by highly transferring fine patterns by injection molding of an alicyclic olefin resin (Patent Reference 4), an antireflection molded article having an antireflection structure in which fine protrusions and depressions having a pitch which is the same as or smaller than the wavelength of light are formed on the surface and the refractive index of the antireflection molded article decreases in the direction of thickness (Patent Reference 5), and an antireflection film having fine protrusions and depressions having a cycle of 35 to 400 nm and a depth of 100 to 700 nm on the surface (Patent Reference 6). However, it is difficult that the reflection of light at the surface of a display is decreased to the completely satisfactory level.

[Patent Reference 1] Japanese Patent Application Laid-Open No. Heisei 7(1995)-168006 (Page 2, FIG. 1)

[Patent Reference 2] Japanese Patent Application Laid-Open No. 2000-71290 (Page 2, FIG. 1)

[Patent Reference 3] Japanese Patent Application Laid-Open No. 2001-272505 (Page 2, FIG. 5)

[Patent Reference 4] Japanese Patent Application Laid-Open No. 2001-323074 (Page 2, FIG. 1)

[Patent Reference 5] Japanese Patent Application Laid-Open No. 2002-267815 (Page 2, FIG. 1)

[Patent Reference 6] Japanese Patent Application Laid-Open No. 2003-43203 (Page 2, FIG. 1)

The present invention has an object of providing an antireflection molded article having a very small reflectance and a process for efficiently producing the article.

### DISCLOSURE OF THE INVENTION

As the result of intensive studies by the present inventors to overcome the above problems, it was found that the reflection of light on the surface having fine protrusions and depressions of an antireflection article could be remarkably decreased by forming protrusions and depressions having pyramidal shapes on the entire antireflection surface with no face portions parallel with the face of the antireflection article and that the reflectance could be remarkably decreased by adjusting the arithmetic average roughness of the incline surfaces of the shape having protrusions and depressions to 100 nm or smaller. The present invention has been completed based on this knowledge.

The present invention provides:

(1) An antireflection molded article which comprises a thermoplastic resin and has an antireflection face comprising protrusions having fine pyramidal shapes or depressions having shapes formed by removing fine pyramids, wherein the antireflection face is entirely formed with inclined faces of the protrusions and the depressions, an average of heights of the protrusions or an average of depths of the depressions is 50 to 600 nm, and an average of shortest distances between vertices of adjacent protrusions or between lowest portions of adjacent depressions is 50 to 400 nm;

(2) The antireflection molded article described in (1), wherein the inclined faces of the protrusions or the depressions has an arithmetic average roughness (Ra) of 100 nm or smaller;

(3) An antireflection molded article which comprises a thermoplastic resin and has an antireflection face having a shape comprising fine protrusions and depressions, wherein the shape comprising fine protrusions and depressions is a shape having ridges formed by tightly arranging thin and long triangular prisms in a horizontal direction without vacant spaces between the prisms, a section of the shape in a direction perpendicular to the ridges formed with the triangular prisms has a shape formed with upward triangles and downward triangles tightly arranged alternately without vacant spaces between the triangles, the antireflection face is entirely formed with inclined faces of protrusions and depressions, an average of heights from the bottom of the depressions to the top of the protrusions is 50 to 600 nm, an average of a shortest distance between vertices of adjacent protrusions is 50 to 400 nm, and the inclined faces of the protrusions and the depressions has an arithmetic average roughness (Ra) of 100 nm or smaller;

(4) An antireflection molded article which comprises a thermoplastic resin and has an antireflection face having a shape comprising fine protrusions or fine depressions, wherein the shape comprising fine protrusions or fine depressions is a shape having ridges formed by arranging thin and long triangular prisms in a horizontal direction with vacant spaces between the prisms or a shape formed by removing thin and long triangular prisms arranged in a horizontal direction with vacant spaces between the prisms, a protruded shape or a depressed shape of a section of the antireflection face in a direction perpendicular to the ridges formed with the triangular prisms is a triangular portion of the article or a triangular space, respectively, the antireflection face comprises inclined faces of the protrusions and the depressions and face portions parallel with the face of the antireflection molded article, an average of heights of the protrusions or depths of the depressions is 50 to 600 nm, an average of a shortest distance between vertices of adjacent protrusions or between lowest portions of adjacent depressions is 50 to 400 nm, and the inclined faces of the protrusions or the depressions has an arithmetic average roughness (Ra) of 100 nm or smaller;

(5) An antireflection molded article which comprises a thermoplastic resin and has a face comprising protrusions having fine pyramidal or conical shapes or depressions having shapes formed by removing fine pyramids or cones, wherein an antireflection face comprises inclined faces of the protrusions or the depressions and face portions parallel with a face of the antireflection molded article, an average of heights of the protrusions or depths of the depressions is 50 to 600 nm, an average of a shortest distance between vertices of adjacent protrusions or between lowest portions of adjacent depressions is 50 to 400 nm, and the inclined faces of the protrusions or the depressions has an arithmetic average roughness (Ra) of 100 nm or smaller;

(6) The antireflection molded article described in any one of (1) to (5), wherein the thermoplastic resin is a resin having an alicyclic structure; and

(7) A process for producing the antireflection molded article described in any one of (1) to (5), which comprises forming a shape having protrusions and depressions, a shape having protrusions or a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and molding the thermoplastic resin into the article in accordance with an injection molding process using a mold having the mold core or the stamper having said shape on the surface.

### BRIEF DESCRIPTION OF THE DRAWINGS

FIG. 1 shows a plan view and a sectional view exhibiting an embodiment of the antireflection molded article of the present invention.

FIG. 2 shows a plan view and a sectional view exhibiting another embodiment of the antireflection molded article of the present invention.

FIG. 3 shows a plan view and a sectional view exhibiting another embodiment of the antireflection molded article of the present invention.

FIG. 4 shows a plan view and a sectional view exhibiting another embodiment of the antireflection molded article of the present invention.

FIG. 5 shows a plan view and a sectional view exhibiting another embodiment of the antireflection molded article of the present invention.

FIG. 6 shows a plan view and a sectional view exhibiting another embodiment of the antireflection molded article of the present invention.

FIG. 7 shows a plan view and a sectional view exhibiting another embodiment of the antireflection molded article of the present invention.

FIG. 8 shows a plan view and a sectional view exhibiting another embodiment of the antireflection molded article of the present invention.

FIG. 9 shows a plan view and a sectional view exhibiting another embodiment of the antireflection molded article of the present invention. In the Figures, the mark 1 means a square pyramid, the mark 2 means a small square pyramid, the mark 3 means a great square pyramid, the mark 4 means a quadrangular pyramid having a rectangular bottom, the mark 5 means a small square pyramid, the mark 6 means a regular triangular pyramid, the mark 7 means a regular hexagonal pyramid, the mark 8 means a depression formed by removing a square pyramid, the mark 9 means a prismal shape, the mark 10 means a protrusion having a prismal shape, the mark 11 means a face portion parallel with the face of the antireflection molded article, the mark 12 means a protrusion having a square pyramidal shape, the mark 13 means a face portion parallel with the face of the antireflection molded article, the mark 14 means a depression having a cone shape, and the mark 15 means a face parallel with the face of the antireflection molded article.

### THE MOST PREFERRED EMBODIMENT TO CARRY OUT THE INVENTION

The first embodiment of the antireflection molded article of the present invention is an antireflection molded article which comprises a thermoplastic resin and has an antireflection face comprising protrusions having fine pyramidal shapes or depressions having shapes formed by removing fine pyramids, wherein the entire surface of the antireflection face is formed with inclined faces of the protrusions and the depressions, the average of heights of the protrusions or the average of depths of the depressions is 50 to 600 nm and preferably 100 to 400 nm, and the average of the shortest distances between vertices of adjacent protrusions or between lowest portions of adjacent depressions is 50 to 400 nm and preferably 100 to 350 nm. It is preferable that, in the antireflection molded article of the present embodiment, the inclined face of the protrusions and the depressions has an arithmetic average roughness (Ra) of 100 nm or smaller, more preferably 50 nm or smaller and most preferably 20 nm or smaller. In the antireflection molded article of the present embodiment, the arithmetic average roughness (Ra) of the inclined face of the protrusions and the depressions is obtained by measuring the lengths of lines connecting the vertex and each edge of the bottom face of the pyramid, followed by obtaining the average of the obtained lengths in accordance with the method of Japanese Industrial Standard B0601. When the average of the heights of the protrusions or the depths of the depressions is smaller than 50 nm, there is the possibility that the sufficient effect of preventing reflection is not exhibited. When the average of the heights of the protrusions or the depths of the depressions exceeds 600 nm, there is the possibility that the production of the antireflection molded article becomes difficult. When the average of distances between the vertices of the adjacent protrusions or between the lowest portions of the adjacent depressions is smaller than 50 nm, there is the possibility that the production of the antireflection molded article becomes difficult. When the average of distances between the vertices of the adjacent protrusions or between the lowest portions of the adjacent depressions exceeds 400 nm, there is the possibility that the effect of preventing reflection is not exhibited. When the arithmetic average roughness (Ra) of the inclined face of the protrusions and the depressions exceeds 100 nm, there is the possibility that the sufficient effect of preventing reflection is not exhibited.

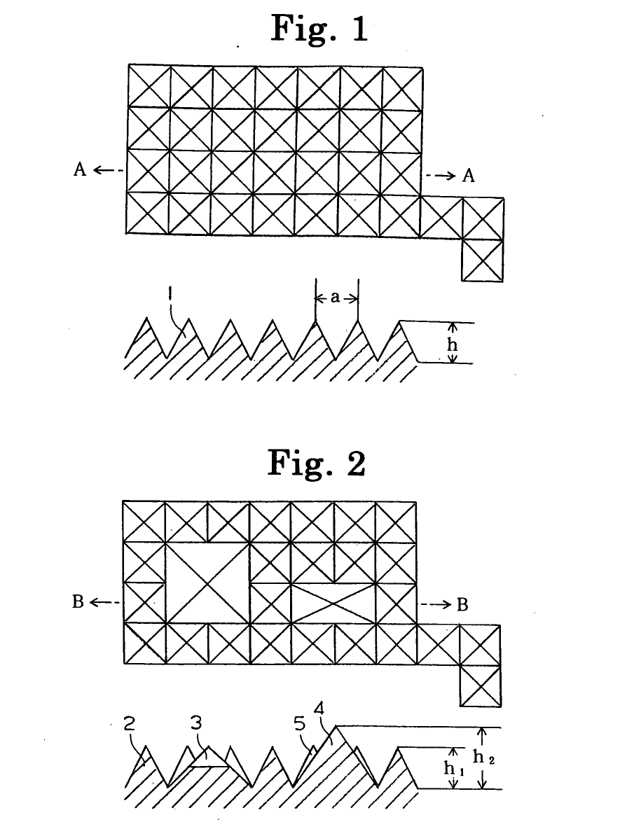

FIG. 1 shows a schematic partial plan view of an embodiment of the antireflection molded article of the present invention and a sectional view thereof cut along the line A-A. In the antireflection molded article of the present embodiment, the antireflection face is constituted entirely with inclined faces of tightly arranged square pyramids 1 having the same shape and has no face portions parallel with the face of the antireflection article. Since the square pyramids all have the same shape, the average of the heights of the protrusions is the same as the height of the single square pyramid h, and the average of the shortest distances between the vertices of adjacent protrusions is the same as the distance a between two adjacent square pyramids.

FIG. 2 shows a schematic partial plan view of another embodiment of the antireflection molded article of the present invention and a sectional view thereof cut along the line B-B. In the antireflection molded article of the present embodiment, small square pyramids 2, great square pyramids 3 and quadrangular pyramids having a rectangular bottom 4 are present on the antireflection face. The antireflection face is entirely constituted with inclined faces of these square pyramids and has no face portions parallel with the face of the antireflection article. The average of the heights of protrusions can be obtained by measuring, for example, heights h₁, h₂ and so on with respect to the entire quadrangular pyramids having different heights, followed by obtaining the average of the obtained values. The average of the shortest distances between vertices of adjacent protrusions can be obtained by measuring the distance between vertices of adjacent small pyramids, the distance between verties of a small pyramid 2 and a great pyramid 3 and the distance between vertices of a quadrangular pyramid having a rectangular bottom 4 and a small square pyramid placed at the shorted distance therefrom 5, followed by obtaining the average of the obtained values.

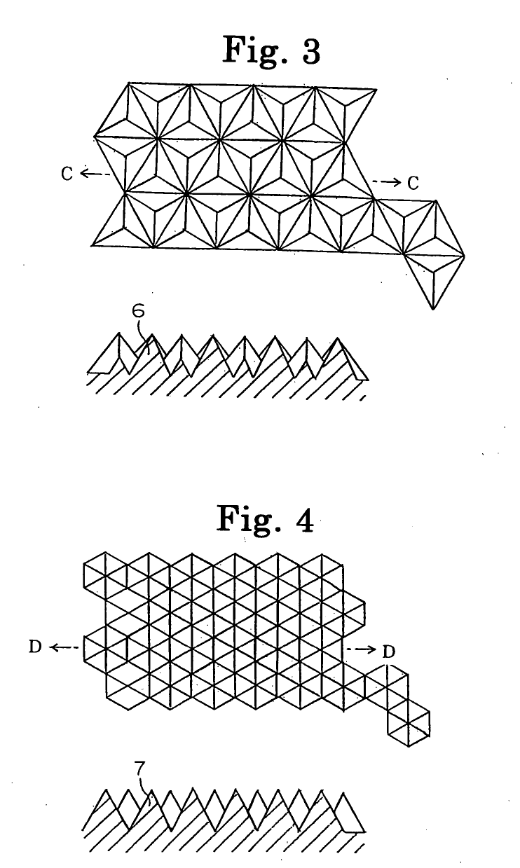

FIG. 3 shows a schematic partial plan view of another embodiment of the antireflection molded article of the present invention and a sectional view thereof cut along the line C-C. In the antireflection molded article of the present embodiment, the antireflection face is constituted entirely with inclined faces of tightly arranged regular triangular pyramids 6 having the same shape and has no face portions parallel with the face of the antireflection article. Since the regular triangular pyramids all have the same shape, the average of the heights of the protrusions is the same as the height of the single regular triangular pyramid, and the average of the shortest distances between the vertices of adjacent protrusions is the same as the distance between vertices of two adjacent regular triangular pyramids.

FIG. 4 shows a schematic partial plan view of another embodiment of the antireflection molded article of the present invention and a sectional view thereof cut along the line D-D. In the antireflection molded article of the present embodiment, the antireflection face is constituted entirely with inclined faces of tightly arranged regular hexagonal pyramids 7 having the same shape and has no face portions parallel with the face of the antireflection article. Since the regular hexagonal pyramids all have the same shape, the average of the heights of the protrusions is the same as the height of the single regular hexagonal pyramid, and the average of the shortest distances between the vertices of adjacent protrusions is the same as the distance between vertices of two adjacent regular hexagonal pyramids.

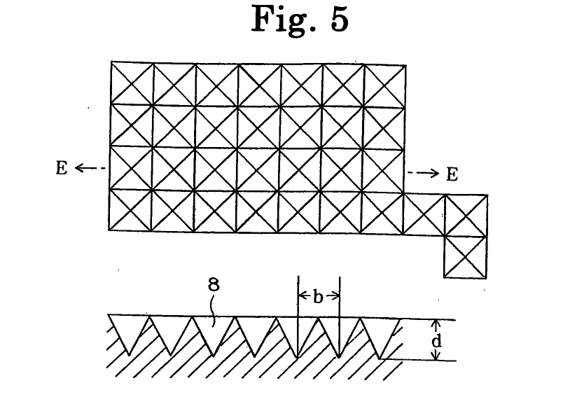

FIG. 5 shows a schematic partial plan view of another embodiment of the antireflection molded article of the present invention and a sectional view thereof cut along the line E-E. In the antireflection molded article of the present embodiment, the antireflection face is constituted entirely with inclined faces of depressions 8 formed by removing tightly arranged square pyramids having the same shape and has no face portions parallel with the face of the antireflection article. Since the depressions formed by removing tightly arranged square pyramids all have the same shape, the average of the depths of the protrusions is the same as the depth of the depression formed by removing a single square pyramid d, and the average of the shortest distances between the bottoms of adjacent protrusions is the same as the distance b between bottoms of two adjacent depressions.

When the refractive index of the air is represented by n_{A} and the refractive index of the thermoplastic resin is represented by n_{R}, the refractive index of a system composed of the air and the thermoplastic resin in amounts such that the volume fraction of the air has a value represented by v_{A} and the volume fraction of the thermoplastic resin has a value represented by v_{R} is given by the following equation:
n=v_{A}·n_{A}+v_{A}·n_{A}
In an antireflection molded article having an antireflection face comprising protrusions having fine pyramidal shapes or depressions having shapes formed by removing fine pyramids, when the distance between adjacent protrusions is smaller than the wavelength of the visible light, the antireflection face having the protrusions and depressions works as a structure having an in-plane refractive index continuously changing from the layer of the air to the substrate material of the thermoplastic resin, and the reflection of the visible light is prevented. In the first embodiment of the antireflection molded article of the present invention, the antireflection face is entirely formed with inclined faces of the protrusions and the depressions, and the in-plane refractive index continuously changes from 1.00 of the layer of the air to 1.53 of the substrate material of the thermoplastic resin when the refractive index of the air n_{A} is 1.00 and the refractive index of the thermoplastic resin n_{R} is 1.53. Therefore, the antireflection molded article exhibits the more excellent effect of preventing reflection than that of an antireflection molded article which has a face portion parallel with the face of the antireflection molded article and shows the in-plane refractive index rapidly changing at the face portion.

The second embodiment of the antireflection molded article of the present invention is an antireflection molded article comprising a thermoplastic resin and having an antireflection face having a shape comprising fine protrusions and depressions, wherein the shape comprising fine protrusions and depressions is a shape having ridges formed by tightly arranging thin and long triangular prisms in a horizontal direction without vacant spaces between the prisms, a section of the shape in a direction perpendicular to the ridges formed with the triangular prisms has a shape formed with upward triangles and downward triangles tightly arranged alternately without vacant spaces between the triangles, the antireflection face is entirely formed with inclined faces of protrusions and depressions, the average of heights of the protrusions from the bottom of the depressions to the top of the protrusions is 50 to 600 nm and preferably 10 to 400 nm, the average of the shortest distance between vertices of adjacent protrusions is 50 to 400 nm and preferably 100 to 350 nm, and the inclined face of the protrusion or the depression has an arithmetic average roughness (Ra) of 100 nm or smaller, preferably 50 nm or smaller and more preferably 20 nm or smaller.

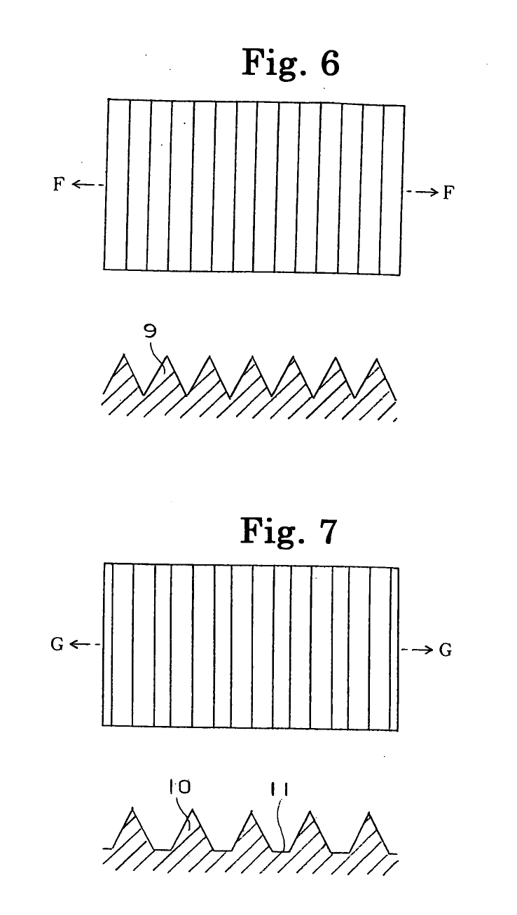

FIG. 6 shows a schematic partial plan view of another embodiment of the antireflection molded article of the present invention and a sectional view thereof cut along the line F-F. In the antireflection molded article of the present embodiment, the antireflection face is constituted entirely with inclined faces of tightly arranged prisms 9 having a linear sectional shape of isosceles triangles and has no face portions parallel with the face of the antireflection article. Since the plurality of protrusions having the square prismal shapes have the same shape, the average of the heights of the protrusions is the same as the height of the prismal shape, and the average of the distances between the vertices of adjacent protrusions is the same as the distance between vertices of two adjacent prisms.

The third embodiment of the antireflection molded article of the present invention is an antireflection molded article which comprises a thermoplastic resin and has an antireflection face having a shape comprising fine protrusions or fine depressions, wherein the shape comprising fine protrusions or fine depressions is a shape having ridges formed by arranging thin and long triangular prisms in a horizontal direction with vacant spaces between the prisms or a shape formed by removing thin and long triangular prisms arranged in a horizontal direction with vacant spaces between the prisms, the section of the protrusion or the depression in the direction perpendicular to the ridge formed with the triangular prism is a triangular portion of the article or a triangular space, respectively, the antireflection face comprises inclined faces of the depressions or the protrusions and face portions parallel with the face of the antireflection molded article, the average of heights of the protrusions or depths of the depressions is 50 to 600 nm and preferably 100 to 400 nm, the average of the shortest distance between vertices of adjacent protrusions or between the lowest portions of adjacent depressions is 50 to 400 nm and preferably 100 to 350 nm, and the inclined face of the protrusion or the depression has an arithmetic average roughness (Ra) of 100 nm or smaller, preferably 50 nm or smaller and more preferably 20 nm or smaller.

FIG. 7 shows a schematic partial plan view of another embodiment of the antireflection molded article of the present invention and a sectional view thereof cut along the line G-G. In the antireflection molded article of the present embodiment, protrusions 10 having a prismal shape having a sectional shape of an isosceles triangle are arranged on the antireflection face with vacant spaces between the protrusions, and face portions 11 parallel with the face of the antireflection molded article are present between the protrusions having the prismal shape. Since the plurality of protrusions having the prismal shapes have the same shape and the distance between the protrusions is the same, the average of the heights of the protrusions is the same as the height of the prismal shape, and the average of the distances between the vertices of adjacent protrusions is the same as the distance between vertices of two adjacent prisms.

The fourth embodiment of the antireflection molded article of the present invention is antireflection molded article which comprises a thermoplastic resin and has a face comprising protrusions having fine pyramidal or conical shapes or depressions having shapes formed by removing fine pyramids or cones, wherein an antireflection face comprises inclined faces of the protrusions or the depressions and face portions parallel with a face of the antireflection molded article, the average of heights of the protrusions or the average of depths of the depressions is 50 to 600 nm and preferably 100 to 400 nm, the average of the shortest distances between vertices of adjacent protrusions or between the lowest portions of adjacent depressions is 50 to 400 nm and preferably 100 to 350 nm, and the inclined face of the protrusion or the depression has an arithmetic average roughness (Ra) of 100 nm or smaller, preferably 50 nm or smaller and more preferably 20 nm or smaller.

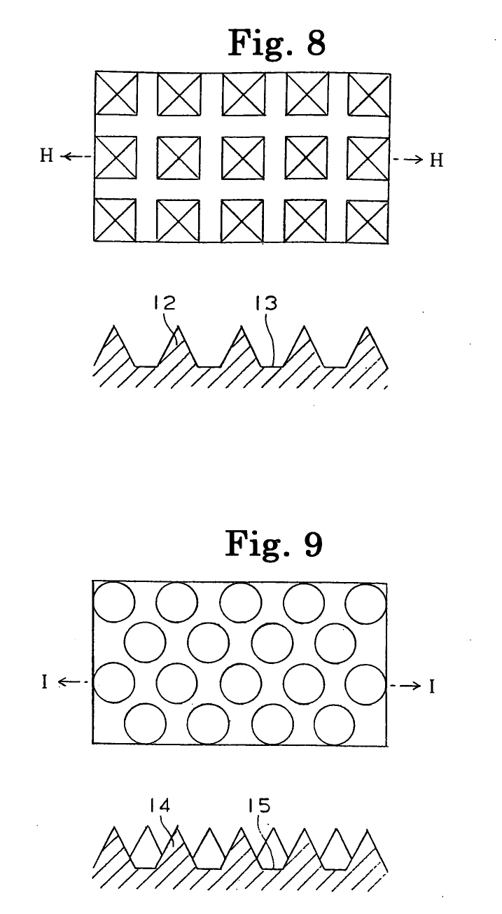

FIG. 8 shows a schematic partial plan view of another embodiment of the antireflection molded article of the present invention and a sectional view thereof cut along the line H-H. In the antireflection molded article of the present embodiment, the antireflection face has protrusions 12 having a square pyramidal shape arranged with space between the protrusions and face portions 13 parallel with the face of the antireflection molded article between the protrusions having the square pyramidal shape. Since the plurality of protrusions having the square pyramidal shapes have the same shape and the distance between the protrusions is the same, the average of the heights of the protrusions is the same as the height of the square pyramid, and the average of the distances between the vertices of adjacent protrusions is the same as the distance between vertices of two adjacent square pyramids.

FIG. 9 shows a schematic partial plan view of another embodiment of the antireflection molded article of the present invention and a sectional view thereof cut along the line I-I. In the antireflection molded article of the present embodiment, the antireflection face has protrusions 14 having the shape of a cone arranged with space between the protrusions and face portions 15 parallel with the face of the antireflection molded article present between the protrusions having the shape of a cone. Since the plurality of protrusions having the shape of a cone have the same shape and the distance between the protrusions are the same, the average of the heights of the protrusions is the same as the height of the cone, and the average of the distances between the vertices of adjacent protrusions is the same as the distance between vertices of two adjacent cones.

In the second embodiment of the antireflection molded article of the present invention, the antireflection face is entirely composed of the inclined faces of the protrusions and the depressions, and no face portions parallel with the face of the antireflection molded article are present. The in-plane refractive index of the antireflection face changes continuously from 1.00 for the layer of the air at the vertices of the shape of the protrusions and the depressions to the refractive index of the thermoplastic resin at the bottom portions, and the excellent effect of preventing reflection can be exhibited.

In the second, third and fourth embodiments of the antireflection molded article of the present invention, when the average of the heights of the protrusions or the depths of the depressions is smaller than 50 nm, there is the possibility that the sufficient effect of preventing reflection is not exhibited. When the distance between the highest portion and the lowest portion in the protrusion and the depression, the depth of the depression, the height of the protrusion, the average of the heights of the protrusions or the average of the depths of the depressions exceeds 600 nm, there is the possibility that the production of the antireflection molded article becomes difficult. When the average of the distances between adjacent protrusions, the average of the shortest distances between adjacent protrusions or adjacent depressions or the average of the shortest distances between vertices of adjacent protrusions or between lowest portions of adjacent depressions is smaller than 50 nm, there is the possibility that the production of the antireflection molded article becomes difficult. When the average of the distance between adjacent protrusions, the average of the shortest distances between adjacent protrusions or adjacent depressions or the average of the shortest distance between vertices of adjacent protrusions or between lowest portions of adjacent depressions exceeds 400 nm, there is the possibility that the sufficient effect of preventing reflection is not exhibited. When the arithmetic average roughness (Ra) of the inclined faces of protrusions and depressions, inclined faces of protrusions or inclined faces of depressions exceeds 100 nm, there is the possibility that the sufficient effect of preventing reflection is not exhibited.

The thermoplastic resin used in the present invention is not particularly limited, and it is preferable that the thermoplastic resin is transparent. It is preferable that a plate molded from the transparent resin and having a thickness of 3 mm has a transmittance of the entire light of 70% or greater, more preferably 80% or greater and most preferably 90% or greater. Examples of the thermoplastic resin include methacrylic resins, polycarbonates, polystyrene, acrylonitrile-styrene copolymer resins, methyl methacrylate-styrene copolymer resins, resins having an alicyclic structure and polyether sulfones. Among these resins, resins having an alicyclic structure are preferable. Since the resins having an alicyclic structure exhibit the excellent fluidity, the fine protrusions and depressions in the mold for the injection molding can be accurately transferred. Since the resins having an alicyclic structure has a small absorption of moisture, an excellent dimensional stability is exhibited, and warp in the antireflection molded article can be prevented. The weight of the antireflection molded article can be decreased due to the small specific gravity.

As the resin having an alicyclic structure, polymer resins having an alicyclic structure in the main chain or in the side chain can be used. The polymer resin having the alicyclic structure in the main chain is preferable due to the excellent mechanical strength and heat resistance. It is preferable that the alicyclic structure is a structure of a saturated cyclic hydrocarbon. The number of the carbon atom in the structure is preferably 4 to 30, more preferably 5 to 20 and most preferably 6 to 15. The fraction of the repeating unit having the alicyclic structure in the polymer resin having an alicyclic structure is preferably 50% by weight or greater, more preferably 70% by weight or greater and most preferably 90% by weight or greater.

Examples of the resin having an alicyclic structure include norbornene-based polymers such as polymers and copolymers obtained by the ring-opening polymerization of norbornene-based monomers, hydrogenation products thereof, polymers and copolymers obtained by the addition polymerization of norbornene-based monomers and hydrogenation products thereof, polymers of cyclic olefin-based monomers having a single ring and hydrogenation products thereof; polymers of cyclic conjugated diene-based monomers and hydrogenation products thereof; polymers and copolymers of vinyl alicyclic hydrocarbon-based monomers and hydrogenation products thereof; and products obtained by hydrogenation of unsaturated portions including aromatic rings of polymers and copolymers of vinyl aromatic hydrocarbon monomers. Among these resins, hydrogenation products of (co)polymers of norbornene-based monomers and products obtained by hydrogenation of unsaturated portions including aromatic rings of polymers and copolymers of vinyl aromatic hydrocarbon monomers are preferable due to the excellent mechanical strength and heat resistance.

In the present invention, the antireflection molded article may comprise other ingredients in combination with the thermoplastic resin. The other ingredients are not particularly limited. Examples of the other ingredient include inorganic fine particles, organic fine particles; stabilizers such as antioxidants, heat stabilizers, light stabilizers, weathering stabilizers, ultraviolet absorbents and, near infrared light absorbents; resin modifiers such as lubricants and plasticizers; coloring agents such as dyes and pigments; and antistatic agents. The other ingredients may be used singly or in combination of two or more. The amount can be suitably selected as long as the object of the present invention is not adversely affected. The amount is, in general, 0 to 5 parts by weight and preferably 0 to 3 parts by weight per 100 parts by weight of the thermoplastic resin.

As the process for producing the antireflection molded article of the present invention, (1) a process which comprises forming a shape having protrusions and depressions, a shape having protrusions or a shape having depressions on the surface of a flat plate made of a thermoplastic resin prepared in advance using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C.; and (2) a process which comprises forming a shape having protrusions and depressions, a shape having protrusions or a shape having depressions on the surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and molding the thermoplastic resin into the article in accordance with an injection molding process using a mold having the mold core or the stamper having said shape on the surface; can be used. Process (2) described above is preferable. A smooth antireflection molded article having inclined faces of the protrusions and the depressions can be efficiently obtained in accordance with process (2). Process (2) will be referred to as “the process of the present invention”, hereinafter. In the process of the present invention, the three-dimensional working of the surface of a mold or a stamper can be conducted with an excellent precision by using the fine cutting machine. The precision of the moving shafts in the X, Y and Z directions of the fine cutting machine is 10 nm or smaller and preferably 1 nm or smaller. When the precision of the moving shafts in the X, Y and Z directions of the fine cutting machine exceeds 10 nm, there is a possibility that it is difficult that the arithmetic average roughness of the inclined faces having a shape having protrusions and depressions, a shape having protrusions or a shape having depressions of 100 nm or smaller is achieved by the working.

In the process of the present invention, a single crystal diamond cutting tool is used for working to form the protrusions and depressions, the protrusions or the depressions on the face of the mold core or the stamper. The cutting can be achieved with an excellent precision by using the single crystal diamond stamper since the resistance in cutting can be decreased and the force for working the face of the mold core or the stamper is decreased from those in the Working using a sintered diamond cutting tool. The arithmetic average roughness (Ra) of the surface of the single crystal diamond cutting tool is 10 nm or smaller and preferably 7 nm or smaller. When the arithmetic average roughness (Ra) of the surface of the single crystal diamond cutting tool exceeds 10 nm, there is a possibility that it becomes difficult that sufficiently smooth inclined faces of the protrusions and depression, the protrusions or the depressions are obtained by the working.

In the present invention, the cutting of the surface of the mold core or the stamper by the fine cutting machine equipped with single crystal diamond cutting tool is conducted in a thermostatted room controlled at a prescribed temperature±0.1° C. and preferably at a prescribed temperature±0.05° C. When the temperature of the environment of cutting the surface of the mold core or the stamper changes in the range exceeding the range of ±0.1° C., there is the possibility that the precision of the cutting deteriorates due to the thermal expansion or thermal contraction of the material of the mold core or the stamper. In the process of the present invention, the injection molding is conducted, in general, at a resin temperature of Tg+100 to Tg+200(° C.) and Tg+150 to Tg+200(° C.) and a mold temperature of Tg−50(° C.) and preferably Tg−30 to Tg(° C.). Tg is the glass transition temperature (° C.) of the used thermoplastic resin.

The antireflection molded article of the present invention is an article obtained in accordance with the injection molding such as light guide panels and light diffuser panels and is advantageously used for products for optical applications which require the antireflection ability.

### EXAMPLES

The present invention will be described more specifically with reference to examples in the following. However, the present invention is not limited to the examples.

In Examples and Comparative Examples, the reflectance was measured using a spectrophotometer [manufactured by NIPPON BUNKO Co., Ltd.; V-570] at an angle of the incident light of 5°, a size of opening for the luminous flux of 7 mmφ and a wavelength in the range of 380 to 780 nm. The arithmetic average roughness (Ra) of inclined faces having protrusions and depressions was measured as follows: faces were observed using an electron microscope of the reflection type [manufactured by HITACHI SEISAKUSHO Co., Ltd.; S-3000N]; then, using an atomic force microscope [manufactured by DIGITAL INSTRUMENTS Co., Ltd.; NANO SCOPE III CONTACT AFM], the distances between the vertex and the four bottom edges were measured for a square pyramid and the distances between the highest position to the lowest position in the direction perpendicular to the direction of the prism along the inclined surface were measured at four positions for a prism both in accordance with the method of Japanese Industrial Standard B0601; and the average value of the obtained values was obtained.

### Example 1

On the surface of a flat plate made of a resin having an alicyclic structure, fine square pyramidal shapes were tightly formed by cutting.

A flat plate having a square shape having a length of an edge of 88.9 mm and a thickness of 1.0 mm was formed from a resin having an alicyclic structure [a norbornene-based polymer; manufactured by NIPPON ZEON Co., Ltd.; ZEON OR 1060R] using an injection molding machine [manufactured by NIPPON SEIKOSHO Co., Ltd.; JSW-ELIII; the pressing force: 1 MN] under conditions of a resin temperature of 310° C., a mold temperature of 100° C. and a cycle time of 150 seconds. On the central portion of a size of 30 mm×30 mm on the surface of the flat plate, square pyramids having a height of 250 nm and a length of an edge of the bottom of 300 nm were formed in a manner such that edges of the bottom of the pyramids were tightly placed together using a fine cutting machine [manufactured by NAGASE INTEGREX Co., Ltd.; an ultraprecision five-shaft CNC controlled fine cutting machine NIC200] and a single crystal diamond cutting tool having an arithmetic average roughness of the surface (Ra) of 3 nm in a thermostatted room controlled at 25.0±0.1° C., and an antireflection molded article having a shape having fine protrusions and depressions on the entire surface of the portion of a size of 30 mm×30 mm was obtained.

The inclined faces of the shape having fine protrusions and depressions of the antireflection molded article had an arithmetic average roughness (Ra) of 10 nm and a reflectance of 0.5%.

### Example 2

An antireflection molded article having fine square pyramidal shapes tightly arranged on the surface was prepared from a resin having an alicyclic structure in accordance with the mold transfer.

On the central portion of a size of 30 mm×30 mm on the surface of a mold core at the moving side in a mold for injection molding to form a flat plate having a square shape having a length of an edge of 88.9 mm and a thickness of 1.0 mm, cavities of square pyramidal shapes having a height of 250 nm and a length of an edge of the bottom of 300 nm were formed in a manner such that edges of the bottom of the pyramids were tightly placed together using a fine cutting machine [manufactured by NAGASE INTEGREX Co., Ltd.; an ultraprecision five-shaft CNC controlled fine cutting machine NIC200] and a single crystal diamond cutting tool having an arithmetic average roughness of the surface (Ra) of 3 nm in a thermostatted room controlled at 25.0±0.1° C., and fine protrusions and depressions were formed on the entire surface of the portion of a size of 30 mm×30 mm.

An antireflection molded article having a square shape having a length of an edge of 88.9 mm and a thickness of 1.0 mm and having square pyramids having a height of 250 nm and a length of an edge of the bottom of 300 nm placed in a manner such that edges of the bottom of the pyramids were tightly placed together on the central portion of the surface having a size of 30 mm×30 mm was formed from a resin having an alicyclic structure [a norbornene-based polymer; manufactured by NIPPON ZEON Co., Ltd.; ZEON OR 1060R] using an injection molding machine [manufactured by NIPPON SEIKOSHO Co., Ltd.; JSW-ELIII; the pressing force: 1 MN] and the mold obtained above at a resin temperature of 310° C., a mold temperature of 100° C. and a cycle time of 150 seconds.

The inclined faces of the shape having fine protrusions and depressions of the antireflection molded article had an arithmetic average roughness (Ra) of 10 nm and a reflectance of 0.5%.

### Example 3

An antireflection molded article having fine prismal shapes tightly arranged on the surface was prepared from a resin having an alicyclic structure in accordance with the mold transfer.

In according with the same procedures as those conducted in Example 2, on the central portion of a size of 30 mm×30 mm on the surface of a mold core at the moving side in a mold having the same size as that in Example 2, grooves having a depth of 250 nm and a width of 300 nm and having a sectional shape cut in the direction perpendicular to the direction of the length of an isosceles triangle were formed in a manner such that adjacent grooves were tightly placed together using a fine cutting machine and a single crystal diamond cutting tool in accordance with the same procedures as those conducted in Example 2, and fine protrusions and depressions were formed on the entire surface of the portion of a size of 30 mm×30 mm.

Injection molding of a resin having an alicyclic structure [a norbornene-based polymer; manufactured by NIPPON ZEON Co., Ltd.; ZEON OR 1060R] was conducted in accordance with the same procedures as those conducted in Example 2 except that the mold prepared above was used, and an antireflection molded article having fine protrusions and depressions formed with protrusions of a prismal shape tightly arranged on the surface was obtained.

The inclined faces of the shape having fine protrusions and depressions of the antireflection molded article had an arithmetic average roughness (Ra) of 10 nm and a reflectance of 50%.

### Example 4

An antireflection molded article having fine prismal shapes arranged on the surface with vacant spaces between the prismal shapes was prepared from a resin having an alicyclic structure in accordance with the mold transfer.

In according with the same procedures as those conducted in Example 2, on the central portion of a size of 30 mm×30 mm on the surface of a mold for injection molding at the moving side having the same size as that in Example 2, grooves having a depth of 250 nm and a width of 300 nm and having a sectional shape cut in the direction perpendicular to the direction of the length of an isosceles triangle were formed in a manner such that the distance between the lowest portions of the adjacent grooves was 350 nm using a fine cutting machine and a single crystal diamond cutting tool, and fine depressions were formed on the entire surface of the portion of a size of 30 mm×30 mm.

Injection molding of a resin having an alicyclic structure [a norbornene-based polymer; manufactured by NIPPON ZEON Co., Ltd.; ZEON OR 1060R] was conducted in accordance with the same procedures as those conducted in Example 2 except that the mold prepared above was used, and an antireflection molded article having fine protrusions and depressions formed with protrusions of a prismal shape having a width of 350 nm and arranged on the surface at a distance of 350 nm between each other was obtained.

The inclined faces of the shape having fine protrusions and depressions of the antireflection molded article had an arithmetic average roughness (Ra) of 10 nm and a reflectance of 60%.

### Example 5

An antireflection molded article having fine square pyramidal shapes arranged on the surface with vacant spaces between the square pyramidal shapes was prepared from a resin having an alicyclic structure in accordance with the mold transfer.

In according with the same procedures as those conducted in Example 2, on the central portion of a size of 30 mm×30 mm on the surface of a mold for injection molding at the moving side having the same size as that in Example 2, cavities having a square pyramidal shape having a depth of 250 nm and a length of an edge of 300 nm was formed at positions corresponding to intersections of an assumed grid having a distance of 350 nm between adjacent lines using a fine cutting machine and a single crystal diamond cutting tool, and fine depressions were formed on the entire surface of the portion of a size of 30 mm×30 mm.

Injection molding of a resin having an alicyclic structure [a norbornene-based polymer; manufactured by NIPPON ZEON Co., Ltd.; ZEON OR 1060R] was conducted in accordance with the same procedures as those conducted in Example 2 except that the mold prepared above was used, and an antireflection molded article having fine protrusions of a square pyramidal shape and arranged on the surface with vacant spaces between the protrusions was obtained.

The inclined faces of the shape having fine protrusions and depressions of the antireflection molded article had an arithmetic average roughness (Ra) of 10 nm and a reflectance of 60%.

### Comparative Example 1

An antireflection molded article having fine prismal shapes tightly arranged on the surface was prepared from a resin having an alicyclic structure in accordance with the laser working and etching.

On the central portion of a size of 30 mm×30 mm on the surface of a flat plate having a square shape having a length of an edge of 88.9 mm and a thickness of 1 mm which was formed in accordance with the injection molding in Example 1, a resist of the positive type was applied in accordance with the spin coating process. Using an ArF excimer laser, prismal shapes having a height of 250 nm, a width of 300 nm and a sectional shape cut along the plane perpendicular to the longitudinal direction of an isosceles triangle were tightly formed in a manner such that the adjacent prisms were arranged without vacant spaces between each other, and the formed structure was developed. The resist thus formed was etched using HF and an aqueous solution of NH₄F as the etching fluids, and an antireflection molded article having fine protrusions and depressions on the entire face of the portion of a size of 30 mm×30 mm on the surface was obtained.

The inclined faces of the shape having fine protrusions and depressions of the antireflection molded article had an arithmetic average roughness (Ra) of 150 nm and a reflectance of 80%.

### Comparative Example 2

An antireflection molded article having fine prismal shapes tightly arranged on the surface was prepared from a resin having an alicyclic structure by transfer from a stamper prepared in accordance with the nickel electric casting process.

After a glass coated with a photosensitive resin in accordance with the spin coating process was treated by patterning in accordance with the method of interference of two luminous fluxes, the etching was conducted using a mixed solution containing H₃PO₄, HNO₃ and CH₃COOH as the etching fluid, and a master model having fine protrusions and depressions was formed on the entire face of a central portion of a size of 30 mm×30 mm. In the master model, grooves which had a depth of 250 nm, a width of 300 nm and a sectional shape cut along the plane perpendicular to the longitudinal direction of an isosceles triangle and were tightly arranged in a manner such that the adjacent prisms were placed without vacant spaces between each other, were formed. A stamper having fine protrusions and depression on the entire face of the central portion of a size of 30 mm×30 mm was prepared by electric casting of nickel on the formed master model. The stamper had grooves which had a depth of 250 nm, a width of 300 nm and a sectional shape cut along the plane perpendicular to the longitudinal direction of an isosceles triangle and were tightly arranged in a manner such that the adjacent prisms were placed without vacant spaces between each other. The stamper was attached to a fixed mold of a mold for injection molding for forming a flat plate having a square shape having a length of an edge of 88.9 mm and a thickness of 1 mm.

Injection molding of a resin having an alicyclic structure [a norbornene-based polymer; manufactured by NIPPON ZEON Co., Ltd.; ZEON OR 1060R] was conducted in accordance with the same procedures as those conducted in Example 2 except that the mold prepared above was used, and an antireflection molded article having fine protrusions and depressions formed with protrusions of a prismal shape tightly arranged with each other on the surface was obtained.

The inclined faces of the shape having fine protrusions and depressions of the antireflection molded article had an arithmetic average roughness (Ra) of 130 nm and a reflectance of 79%.

### Comparative Example 3

An antireflection molded article prepared in accordance with the same procedures as those conducted in Example 5 was dipped into HF and an aqueous solution of NH₄F as the etching fluids, washed with water and dried, and an antireflection molded article having fine protrusions and depressions formed with protrusions of a square pyramidal shape arranged with vacant spaces between each other on the surface was obtained.

The inclined faces of the shape having fine protrusions of the antireflection molded article had an arithmetic average roughness (Ra) of 150 nm and a reflectance of 30%.

The results in Examples 1 to 5 and Comparative Example 1 to 3 are shown in Table 1.

TABLE 1

| | | | | | Arithmetic average | |
|---|---|---|---|---|---|---|
| | Shape of fine | | | | roughness of inclined | |
| | protrusions and | Process for | Process for preparing | Thermoplastic | faces | Reflectance |
| | depressions | forming shape | mold or stamper | resin | (nm) | (%) |
| Example 1 | square pyramidal, | cutting molded | — | alicyclic structure | 10 | 0.5 |
| | arranged tightly | article | | | | |
| Example 2 | square pyramidal, | injection molding | fine cutting machine | alicyclic structure | 10 | 0.5 |
| | arranged tightly | | | | | |
| Example 3 | prismal, arranged | injection molding | fine cutting machine | alicyclic structure | 10 | 50 |
| | tightly | | | | | |
| Example 4 | prismal, arranged | injection molding | fine cutting machine | alicyclic structure | 10 | 60 |
| | with space | | | | | |
| Example 5 | square pyramidal, | injection molding | fine cutting machine | alicyclic structure | 10 | 1.0 |
| | arranged with space | | | | | |
| Comparative | prismal, arranged | working by laser | — | alicyclic structure | 150 | 80 |
| Example 1 | tightly | | | | | |
| Comparative | prismal, arranged | injection molding | nickel electric casting | alicyclic structure | 130 | 79 |
| Example 2 | tightly | | | | | |
| Comparative | square pyramidal, | injection molding | roughening with etching | alicyclic structure | 150 | 30 |
| Example 3 | arranged with space | | fluid after working by | | | |
| | | | fine cutting machine | | | |

The following can be shown from the results in Table 1.

In the cases of the fine protrusions and depressions having a square pyramidal shape, the reflectance was very small (0.5%, 0.5% and 1%) when the arithmetic average roughness (Ra) of the inclined faces of the protrusions and depressions was 10 nm in accordance with the present invention (Examples 1, 2 and 5, respectively). In contrast, the reflectance was great (30%) when the arithmetic average roughness (Ra) of the inclined faces of the protrusions and depression exceeded 100 nm Comparative Example 3).

In the cases of the fine protrusions and depressions having a prismal shape, the reflectance was very small (50%, and 60%) when the arithmetic average roughness (Ra) of the inclined faces of the protrusions and depressions was 10 nm in accordance with the present invention (Examples 3 and 4, respectively). In contrast, the reflectance was great (80% and 79%%) when the arithmetic average roughness (Ra) of the inclined faces of the protrusions and depression exceeded 100 nm (Comparative Example 1 and 2, respectively).

### INDUSTRIAL APPLICABILITY

The antireflection molded article of the present invention has a very smooth surface formed with the inclined faces of the fine protrusions and depressions. Therefore, the antireflection molded article has a small reflectance and exhibits excellent antireflection property. In accordance with the process of the present invention, the antireflection molded article having the above advantage can be efficiently produced in accordance with the injection molding process.

1-7. (canceled)

8. An antireflection molded article which comprises a thermoplastic resin and has an antireflection face comprising (a) protrusions having fine pyramidal shapes or (b) depressions having shapes formed by removing fine pyramids, wherein the antireflection face is entirely formed with inclined faces of the protrusions and the depressions, an average of heights of the protrusions or an average of depths of the depressions is 50 to 600 nm, and an average of shortest distances between vertices of adjacent protrusions or between lowest portions of adjacent depressions is 50 to 400 nm.

9. The antireflection molded article according to claim 8, wherein the inclined faces of the protrusions or the depressions has an arithmetic average roughness (Ra) of 100 nm or smaller.

10. An antireflection molded article which comprises a thermoplastic resin and has an antireflection face having a shape comprising fine protrusions and depressions, wherein the shape comprising fine protrusions and depressions is a shape having ridges formed by tightly arranging thin and long triangular prisms in a horizontal direction without vacant spaces between the prisms, a section of the shape in a direction perpendicular to the ridges formed with the triangular prisms has a shape formed with upward triangles and downward triangles tightly arranged alternately without vacant spaces between the triangles, the antireflection face is entirely formed with inclined faces of protrusions and depressions, an average of heights from the bottom of the depressions to the top of the protrusions is 50 to 600 nm, an average of a shortest distance between vertices of adjacent protrusions is 50 to 400 nm, and the inclined faces of the protrusions and the depressions has an arithmetic average roughness (Ra) of 100 nm or smaller.

11. An antireflection molded article which comprises a thermoplastic resin and has an antireflection face having a shape comprising fine protrusions or fine depressions, wherein the shape comprising fine protrusions or fine depressions is a shape having ridges formed by arranging thin and long triangular prisms in a horizontal direction with vacant spaces between the prisms or a shape formed by removing thin and long triangular prisms arranged in a horizontal direction with vacant spaces between the prisms, a protruded shape or a depressed shape of a section of the antireflection face in a direction perpendicular to the ridges formed with the triangular prisms is a triangular portion of the article or a triangular space, respectively, the antireflection face comprises inclined faces of the protrusions and the depressions and face portions parallel with the face of the antireflection molded article, an average of heights of the protrusions or depths of the depressions is 50 to 600 nm, an average of a shortest distance between vertices of adjacent protrusions or between lowest portions of adjacent depressions is 50 to 400 nm, and the inclined faces of the protrusions or the depressions has an arithmetic average roughness (Ra) of 100 nm or smaller.

12. An antireflection molded article which comprises a thermoplastic resin and has a face comprising protrusions having fine pyramidal or conical shapes or depressions having shapes formed by removing fine pyramids or cones, wherein an antireflection face comprises inclined faces of the protrusions or the depressions and face portions parallel with a face of the antireflection molded article, an average of heights of the protrusions or depths of the depressions is 50 to 600 nm, an average of a shortest distance between vertices of adjacent protrusions or between lowest portions of adjacent depressions is 50 to 400 nm, and the inclined faces of the protrusions or the depressions has an arithmetic average roughness (Ra) of 100 nm or smaller.

13. The antireflection molded article according to claim 8, wherein the thermoplastic resin is a resin having an alicyclic structure.

14. The antireflection molded article according to claim 9, wherein the thermoplastic resin is a resin having an alicyclic structure.

15. The antireflection molded article according to claim 10, wherein the thermoplastic resin is a resin having an alicyclic structure.

16. The antireflection molded article according to claim 11, wherein the thermoplastic resin is a resin having an alicyclic structure.

17. The antireflection molded article according to claim 12, wherein the thermoplastic resin is a resin having an alicyclic structure.

18. A process for producing the antireflection molded article described in claim 8, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

19. A process for producing the antireflection molded article described in claim 9, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

20. A process for producing the antireflection molded article described in claim 10, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

21. A process for producing the antireflection molded article described in claim 11, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

22. A process for producing the antireflection molded article described in claim 12, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

23. A process for producing the antireflection molded article described in claim 13, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

24. A process for producing the antireflection molded article described in claim 14, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

25. A process for producing the antireflection molded article described in claim 15, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

26. A process for producing the antireflection molded article described in claim 16, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.

27. A process for producing the antireflection molded article described in claim 17, which comprises:
(i) forming a shape selected from the group consisting of (a) a shape having protrusions and depressions, (b) a shape having protrusions and (c) a shape having depressions on a surface of a mold core or a stamper using a fine cutting machine having a precision of moving shafts in X, Y and Z directions of 10 nm or smaller and a single crystal diamond cutting tool having a surface having an arithmetic average roughness (Ra) of 10 nm or smaller in a thermostatted room controlled at a prescribed temperature±0.1° C., and
(ii) molding the thermoplastic resin into said article in accordance with an injection molding process using a mold assembled with said mold core or said stamper.
